(19) United States
(12) Patent Application Publication
(10) Pub. No.: US 2012/0277094 A1
(43) Pub. Date: Nov. 1, 2012

(54) CATALYST SUPPORT OR CATALYST, AND PROCESS FOR PRODUCING THE SAME

(75) Inventors: Yusuke Ogata, Hamamatsu-shi (JP); Ryou Suzuki, Hamamatsu-shi (JP); Akihiko Tomoda, Hamamatsu-shi (JP)

(73) Assignee: Kabushiki Kaisha F.C.C., Hamamatsu-shi (JP)

(21) Appl. No.: 13/480,423

(22) Filed: May 24, 2012

Related U.S. Application Data
(63) Continuation of application No. PCT/JP2010/069351, filed on Oct. 29, 2010.

(30) Foreign Application Priority Data
Nov. 25, 2009 (JP) 2009-267622

(51) Int. Cl. B01J 21/04

(52) U.S. Cl. 502/304; 502/439; 502/341; 502/328

(57) ABSTRACT

A catalyst support can be produced by undergoing solution-preparation step S1, solution-filling step S2, drying step S3, calcination step S4, and firing step S5. The catalyst support or catalyst can include magnesium aluminate (MgAl₂O₄) having a specific surface area of 80 to 150 m²/g and a pore volume of 0.45 to 0.65 ml/g, the magnesium aluminate capable of having a precious metal supported thereon.

### CROSS-REFERENCE TO RELATED APPLICATIONS

This application is a continuation of PCT Application No. PCT/JP2010/069351, filed on Oct. 29, 2010, which claims priority to Japanese Application No. 2009-267622, filed on Nov. 25, 2009, the entire contents of each of which are hereby incorporated by reference.

### FIELD OF THE INVENTION

The present inventions relate to catalyst supports or catalysts including magnesium aluminate (MgAl₂O₄) having a precious metal supported thereon, and to processes for producing the catalyst supports or catalysts.

### BACKGROUND OF THE INVENTION

In general, exhaust purification catalysts seems to degrade in performance due to particle growth of precious metal microparticles that serve as the catalytic component. Such catalyst devices are typically manufactured by dispersing the precious metal microparticles on the surface of a heat-resistant alumina support (a catalyst support). As ambient temperature increases during use, the microparticles diffuse and migrate over the alumina support and aggregate, thereby leading to particle growth, reduction in the specific surface area of the precious metal thereby reducing the catalytic reaction rates.

Reducing such precious metal microparticle diffusion and migration on the support surface can reduce the degradation of the performance of the precious metal catalyst. Accordingly, technological development has been progressing.

For example, Japanese Unexamined Patent Application Publication No. 2003-135963 discloses a method for reducing microparticle migration and diffusion by trapping precious metal microparticles in alumina support pores. In the foregoing method, when the precious metal microparticles are trapped in the alumina pores, oxide particles such as cerium oxide, zirconium oxide, or magnesium oxide are simultaneously trapped together with the precious metal microparticles. Thus, the prevention of precious metal microparticle aggregation in pores has been considered.

Accordingly, a perovskite-type complex oxide catalyst having excellent heat resistance has recently been drawing attention. Such a perovskite-type complex oxide is denoted by ABO₃, and is frequently composed of A: lanthanum (La) and B: iron (Fe), cobalt (Co), or manganese (Mn). Such a perovskite-type complex oxide (e.g., LaFeO₃, LaCoO₃, or LaMnO₃) alone possesses an exhaust purification ability. Unfortunately, the perovskite-type complex oxide catalyst noted above resulted a lower exhaust gas volume capacity and particularly, poor NO (nitrogen oxide) gas purification performance. In order to overcome these disadvantages, a catalyst has been proposed, including LaFe(1−x)PdₓO₃ in which a portion of LaFeO₃ is substituted by a precious metal (Pd, Palladium) (e.g., see Japanese Unexamined Patent Application Publication No. 5-31367).

### SUMMARY OF THE INVENTIONS

An aspect of at least one of the inventions disclosed herein includes the realization that the above conventional catalyst support and catalyst do not perform acceptably when used for treating exhaust gas emitted from certain types of internal combustion engines.

Specifically, the conventional catalyst using a perovskite-type complex oxide catalyst has no deterioration in HC, CO, and/or NO purification performance after thermal treatment at 900° C. for 100 hours. Thus, an internal combustion engine powered vehicle has already used this catalyst.

However, more recently, internal combustion engines using higher temperature combustion technology have been developed for improving thermal efficiency of engines. The higher combustion temperatures of these engines produce higher flue gas temperatures.

Additionally, in order to quickly raise the temperature of the catalyst to its operating temperature, for example during cold-start periods, some catalyst deices have been placed immediately below an engine. Accordingly, such a catalyst can be subjected to higher temperatures that can exceed 900° C. The above-described perovskite-type complex oxide catalyst has insufficient heat resistance and durability for use with the above noted higher combustion temperature engines.

It has been known that an alkali metal and an alkali earth metal are basic metals, and adsorb acidic gas such as CO₂ and NOₓ to readily produce carbonate and nitrate salt, respectively. Thus, by utilizing this characteristic, an NOₓ adsorption and reduction catalyst for exhaust purification used for a higher combustion temperature, lean burn engine has been developed and proposed. In this NOₓ adsorption and reduction catalyst, Ba (barium) is used as an alkali earth metal. Accordingly, NOₓ included in an exhaust gas is enriched on Ba ions to produce nitrate. Hydrocarbon (fuel oil) as an NOₓ-reducing agent, are injected thereto in a form of pulse, to reduce NOₓ into harmless N₂.

The present applicant has focused on magnesium (Mg), which has a high affinity for NOₓ, and intensively examined, as a catalyst support, use of alumina on which Mg ions are uniformly dispersed (i.e., magnesium aluminate (MgAl₂O₄: the mineral name is spinel). Although it seems that magnesium oxide powder and alumina powder, for example, can be mixed and heated at a high temperature (1400° C. or higher) to produce magnesium aluminate (MgAl₂O₄), the resulting magnesium aluminate (MgAl₂O₄) is very hard and has a markedly small specific surface area. Hence, the magnesium aluminate resulting from mixing and heating magnesium oxide powder and alumina powder is unsuitable for use as a catalyst support.

An aspect of at least one of the inventions disclosed herein includes the realization that magnesium aluminate (MgAl₂O₄) catalyst support can be produced in different ways with sufficiently high specific surface area, temperature resistance, and NOₓ purification performance. Thus one of the embodiments disclosed herein includes a catalyst support or catalyst which can use magnesium aluminate (MgAl₂O₄) as a catalyst support, improved heat resistance, and support improved NOₓ purification performance. Another embodiment includes a

At least one embodiment disclosed herein is directed to a process for producing a catalyst support produced by having magnesium aluminate (MgAl₂O₄) formed in pores of porous alumina, the magnesium aluminate having a precious metal supported thereon. The process can include a solution-preparation step of preparing a magnesium-ion-containing aqueous solution, a solution-filling step of filling the pores of the porous alumina with the aqueous solution as obtained in the solution-preparation step by using a pore-filling method utilizing capillarity occurring in the pores, a drying step of drying the porous alumina having the pores filled with the aqueous solution in the solution-filling step, and a firing step of firing the porous alumina as obtained in the drying step to produce magnesium aluminate.

Some embodiments can further include adjusting the concentration of the aqueous solution as obtained in the solution-preparation step so that an amount of the magnesium aluminate formed on the porous alumina during the firing step is adjustable.

Some embodiments can further include a cerium-dioxide-addition step of adding cerium dioxide (CeO₂) to the magnesium aluminate as produced in the firing step.

At least a further embodiment disclosed herein is directed to a process for producing a catalyst produced by having magnesium aluminate (MgAl₂O₄) formed in pores of porous alumina, the magnesium aluminate having a precious metal supported thereon. The process can include a solution-preparation step of preparing a magnesium-ion-containing aqueous solution, a solution-filling step of filling the pores of the porous alumina with the aqueous solution as obtained in the solution-preparation step by using a pore-filling method utilizing capillarity occurring in the pores, a drying step of drying the porous alumina having the pores filled with the aqueous solution in the solution-filling step, and a firing step of firing the porous alumina as obtained in the drying step to produce magnesium aluminate, wherein the pores of the porous alumina fired in the firing step are filled with a precious-metal-containing aqueous solution by using the pore-filling method utilizing capillarity occurring in the pores of the porous alumina.

Some embodiments can further use palladium as the precious metal.

[Some embodiments can further include a cerium-dioxide-addition step of adding cerium dioxide (CeO₂) to the magnesium aluminate as produced in the firing step, wherein the precious metal is supported on a catalyst support which has undergone the cerium-dioxide-addition step.

At least one additional embodiment is directed to a catalyst support including magnesium aluminate (MgAl₂O₄) having a specific surface area of 80 to 150 m²/g and a pore volume of 0.45 to 0.65 ml/g, the magnesium aluminate capable of having a precious metal supported thereon.

Some embodiments can further include the magnesium aluminate (MgAl₂O₄) formed in pores of porous alumina.

Some embodiments can further include cerium dioxide (CeO₂) added to the magnesium aluminate.

At least one additional embodiment is directed to a catalyst including a catalyst support including magnesium aluminate (MgAl₂O₄) having a specific surface area of 80 to 150 m²/g and a pore volume of 0.45 to 0.65 ml/g, wherein a precious metal is supported on the magnesium aluminate.

Some embodiments can further include the magnesium aluminate (MgAl₂O₄) disposed in pores of porous alumina.

Some embodiments can further include palladium as the precious metal.

Some embodiments can further include cerium dioxide (CeO₂) added to the magnesium aluminate, wherein the precious metal is made to be supported on the catalyst support containing the cerium dioxide.

As noted above, some embodiments provide a catalyst support or catalyst including magnesium aluminate (MgAl₂O₄) having a specific surface area of 80 to 150 m²/g and a pore volume of 0.45 to 0.65 ml/g, the magnesium aluminate capable of having a precious metal supported thereon. Accordingly, the magnesium aluminate (MgAl₂O₄) can be used as a catalyst support, can improve heat resistance and provide sufficient NOₓ purification performance.

For example, pores of porous alumina are filled with an aqueous solution as obtained in a solution-preparation step. Then, the porous alumina is subjected to drying to precipitate magnesium aluminate (MgAl₂O₄) in the pores. In such a case, a catalyst support and catalyst can be more readily produced which can maintain HC, CO, and/or NO purification performance even after long-term exposure under an atmosphere having a high temperature of, for example, about 1000° C. Further, palladium (Pd) is used as a precious metal which is supported on a catalyst support including magnesium aluminate (MgAl₂O₄). Accordingly, a low-cost catalyst having excellent purification performance can be produced.

Moreover, cerium dioxide (CeO₂) can be added to the magnesium aluminate, and a precious metal is supported on a catalyst support containing the above cerium dioxide. Consequently, this should allow for effects of being able to maintain NO purification performance, to sufficiently respond to a change in oxygen level, and for example, to provide a stoichiometric reaction atmosphere.

### BRIEF DESCRIPTION OF THE DRAWINGS

FIG. 1 is a flow chart showing a process for producing a catalyst support according to an embodiment of the present invention.

FIG. 2 is an XRD graph verifying whether or not magnesium aluminate (spinel) according to any one of Examples 1 to 6 is produced.

FIG. 3 is a graph showing purification characteristics of Example 7.

FIG. 4 is a graph showing purification characteristics of Example 3.

FIG. 5 is a graph showing evaluation results of HC purification activity at 450° C. with regard to Examples 7 to 10 and a Comparative Example.

FIG. 6 is a graph showing evaluation results of HC purification activity at 500° C. with regard to Examples 7 to 10 and a Comparative Example.

FIG. 7 is a graph showing evaluation results of NO purification activity at 450° C. with regard to Examples 7 to 10 and a Comparative Example.

FIG. 8 is a graph showing evaluation results of NO purification activity at 500° C. with regard to Examples 7 to 10 and a Comparative Example.

FIG. 9 is graphs showing purification rates under each condition where an oxygen level varies in Example 7.

FIG. 10 is a schematic diagram showing a process for producing a ceria-spinel catalyst according to another embodiment of the present invention.

FIG. 11 is a graph showing HC purification rates (at 450° C.) of a ceria-spinel catalyst according to Example 11 and a catalyst according to Comparative Example.

FIG. 12 is a graph showing HC purification rates (at 500° C.) of a ceria-spinel catalyst according to Example 11 and a catalyst according to Comparative Example.

### DETAILED DESCRIPTION OF THE PREFERRED EMBODIMENT

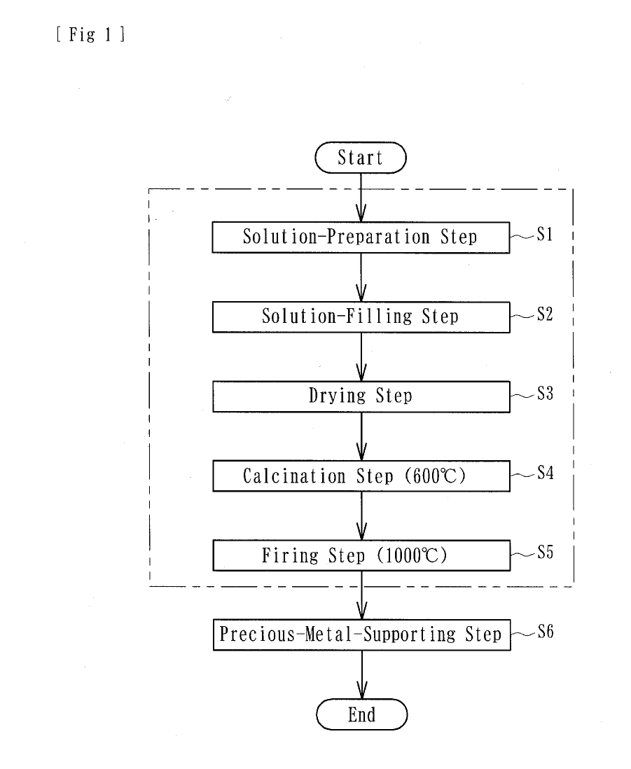

At least one of the embodiments disclosed herein provides a catalyst support including magnesium aluminate (MgAl₂O₄) having a specific surface area of 80 to 150 m²/g and a pore volume of 0.45 to 0.65 ml/g, the magnesium aluminate being capable of having a precious metal supported thereon. As illustrated in FIG. 1, the catalyst support can be produced by undergoing: a solution-preparation step S1; a solution-filling step S2; a drying step S3; a calcination step S4; and a firing step S5. In addition, an exhaust purification catalyst can be obtained by carrying out a precious-metal-supporting step S6.

The solution-preparation step S1 can include a step of preparing a magnesium (Mg)-ion-containing aqueous solution. For example, a magnesium-nitrate-containing aqueous solution can be used as the magnesium (Mg)-ion-containing aqueous solution.

The solution-filling step S2 can include a step of filling pores of porous alumina with the aqueous solution as obtained in the solution-preparation step S1 by using a pore-filling method utilizing capillarity occurring in the pores. This pore-filling method can include the steps of: measuring a pore volume of an alumina support (a catalyst support); adding an aqueous solution (i.e., the aqueous solution as obtained in the solution-preparation step S1 in this embodiment) at a volume equivalent to the pore volume; and performing mixing and stirring thereof so that the pores of the alumina support (the catalyst support) are filled with the aqueous solution by using capillarity.

The drying step S3 can include a step of drying the porous alumina whose pores are filled with the aqueous solution in the solution-filling step S2. This step can achieve a state in which the wall surface of the catalyst support pores is covered (coated) with components for producing magnesium aluminate (MgAl₂O₄). The calcination step S4 includes a step of calcinating the catalyst support dried in the drying step S3 at, for example, about 600° C. The firing step S5 includes a step of firing, in air and at about 1000° C., the porous alumina which has been obtained in the drying step S3 and has undergone the calcination step S4, so that magnesium aluminate (MgAl₂O₄) is produced in the pores thereof.

By undergoing the above steps S1 to S5, a catalyst support according to an embodiment can be produced. This catalyst support includes magnesium aluminate (MgAl₂O₄) having a specific surface area of 80 to 150 m²/g and a pore volume of 0.45 to 0.65 ml/g. After that, an exhaust purification catalyst can be produced by supporting a precious metal (palladium) on the magnesium aluminate (MgAl₂O₄) in the precious-metal-supporting step S6.

The foregoing precious-metal-supporting step S6 can include a step of filling pores of the catalyst support fired in the firing step S5 with a precious-metal (palladium)-containing aqueous solution by using a pore-filling method utilizing capillarity occurring in the pores. Accordingly, a catalyst according to an embodiment can be produced.

Optionally, a nitric acidic aqueous solution containing a dinitro-diammine-palladium salt or palladium nitrate can be used as the palladium (Pd)-containing aqueous solution for filling the pores using a pore-filling method. A palladium catalyst can be produced by filling the catalyst support with the above aqueous solution, drying, and calcinating at 600° C. for 4 hours. Although another precious metal such as platinum (Pt) or rhodium (Rh) may be used as a substitute for palladium, it is preferable that palladium be supported as in this embodiment because palladium is a relatively low cost material.

According to the above process for producing a catalyst support and a catalyst, by using a pore-filling method, pores of porous alumina are filled with an aqueous solution as obtained in a solution-preparation step, the porous alumina is subjected to drying and firing to precipitate magnesium aluminate (MgAl₂O₄) in the pores. Consequently, a catalyst support and a catalyst can be easily obtained which can maintain HC, CO, and/or NOₓ purification performance even after long-term exposure under an atmospheric condition having a high temperature of, for example, about 1000° C.

In particular, by using a pore-filling method, pores of porous alumina are filled with an aqueous solution as obtained in a solution-preparation step, the porous alumina is subjected to drying and firing to precipitate magnesium aluminate (MgAl₂O₄) in the pores. Consequently, a catalyst support and catalyst can be more readily produced which can maintain HC, CO, and/or NOₓ purification performance even after long-term exposure under an atmosphere having a high temperature of, for example, about 1000° C. Further, palladium (Pd) is used as a precious metal which is supported on a catalyst support including magnesium aluminate (MgAl₂O₄). Accordingly, a low-cost catalyst having excellent purification performance can be produced.

Moreover, the concentration of an aqueous solution as obtained in the solution-preparation step S1 can be optionally adjusted. Hence, the amount of magnesium aluminate formed on the porous alumina in the firing step S5 is adjustable. That is, the concentration of the aqueous solution as obtained in the solution-preparation step S1 is made low, so that all of the porous alumina may be replaced by magnesium aluminate or only a portion of the porous alumina may be replaced by magnesium aluminate (in other words, the surface layer of the porous alumina is replaced by magnesium aluminate, and the core portion of the support still remains as alumina).

In addition, a catalyst according to some embodiments possesses a catalyst support including magnesium aluminate (MgAl₂O₄) having a specific surface area of 80 to 150 m²/g and a pore volume of 0.45 to 0.65 ml/g, the magnesium aluminate having a precious metal supported thereon. Thus, the catalytic action of the precious metal and the effect of basic magnesium (Mg) allow for excellent simultaneous purification of hydrocarbon (HC), carbon monoxide (CO), and nitric oxide (NOₓ) which are emitted from an internal combustion engine, a combustion device, or the like.

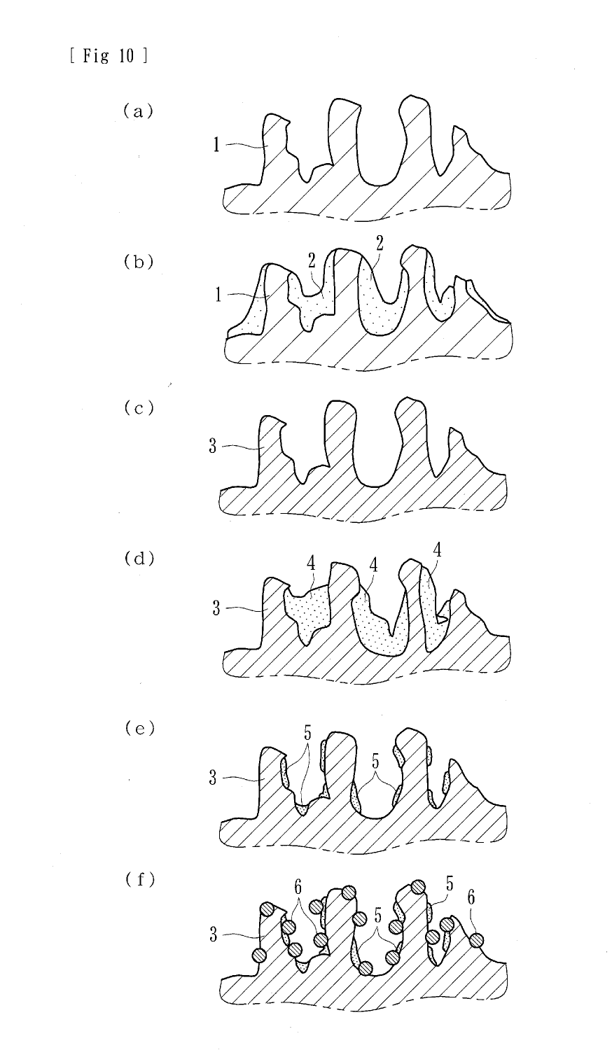

Furthermore, as another embodiment of, cerium dioxide (CeO₂) may be added to the catalyst support including magnesium aluminate (MgAl₂O₄) according to the above embodiment. With reference to FIG. 10, a production process of this embodiment is described below.

First, porous alumina 1 (see FIG. 10(a)) having a specific surface area of 247 m²/g is prepared. Next, pores of the porous alumina 1 are filled with a magnesium (Mg)-ion-containing aqueous solution 2 (a magnesium nitrate aqueous solution) as obtained in a solution-preparation step similar to the above by using a pore-filling method (a solution-filling step) (see FIG. 10(b). Then, the porous alumina is dried in the drying step and fired (1000° C.) to yield magnesium aluminate (MgAl₂O₄) (spinel 3) having a specific surface area of 83 m²/g (see FIG. 10(c)).

Pores of spinel 3 as so obtained are filled with an aqueous solution 4 (a cerium nitrate aqueous solution) by using a pore-filling method, and then dried and fired (at 900° C.) (a cerium-dioxide-addition step) to produce a ceria spinel (CeO₂/MgAl₂O₄) having a specific surface area of 74 m²/g, the ceria spinel being produced by adding cerium dioxide 5 (CeO₂) to the magnesium aluminate (MgAl₂O₄) (spinel 3) (see FIG. 10(e)). In cerium oxide included in such a ceria spinel (CeO₂/MgAl₂O₄), the oxidation-reduction potential of Ce⁴⁺ and Ce³⁺ is about 1.6 V and thus low. The reaction reversibly proceeds and the oxygen storage capacity (OSC) is maintained. Consequently, the ceria spinel can sufficiently respond to a change in oxygen level.

After that, in the precious-metal-supporting step, a precious metal 6 (palladium) is supported on a catalyst support containing cerium dioxide 5 (CeO₂) to produce an exhaust purification catalyst (a Pd-supported ceria-spinel catalyst). The foregoing precious-metal-supporting step includes a step of filling pores of the catalyst support fired in the firing step in a manner similar to the above embodiment with a precious-metal (palladium)-containing aqueous solution by using a pore-filling method utilizing capillarity occurring in the pores.

According to another embodiment as described above, cerium dioxide (CeO₂) is added to magnesium aluminate (a cerium-dioxide-addition step), and a precious metal is supported on a catalyst support which has undergone the cerium-dioxide-addition step. Consequently, this should maintain NO purification performance, sufficiently respond to a change in oxygen level, and for example, make a reaction atmosphere reach a stoichiometric state. In view of the above, the above effects should result if cerium dioxide and a precious metal coexist as in this embodiment. In some embodiments, sites where a precious metal is added via cerium dioxide and sites where a precious metal is not added via cerium dioxide, may be present.

Hereinafter, experimental results demonstrating specific characteristics, etc., of the present embodiments are described by using Examples.

### Experiment 1

### Synthesis and Characterization of Magnesium Aluminate (MgAl2O4: Spinel)

As a MgO precursor, magnesium nitrate hexahydrate (Mg(NO₃)₂.6H₂O) was used, and 25.6 g (0.1 mol) of this magnesium nitrate hexahydrate was dissolved in distilled water to prepare 10.2 ml of a magnesium nitrate aqueous solution (a solution-preparation step). This aqueous solution was added dropwise to 10.2 g (0.1 mol) of commercially available alumina powder (specific surface area: 247 m²/g, pore volume: 1.0 ml/g). Next, while the mixture was mixed in a mortar, pores of the alumina were filled with the foregoing aqueous solution (solution-filling step using pore-filling method).

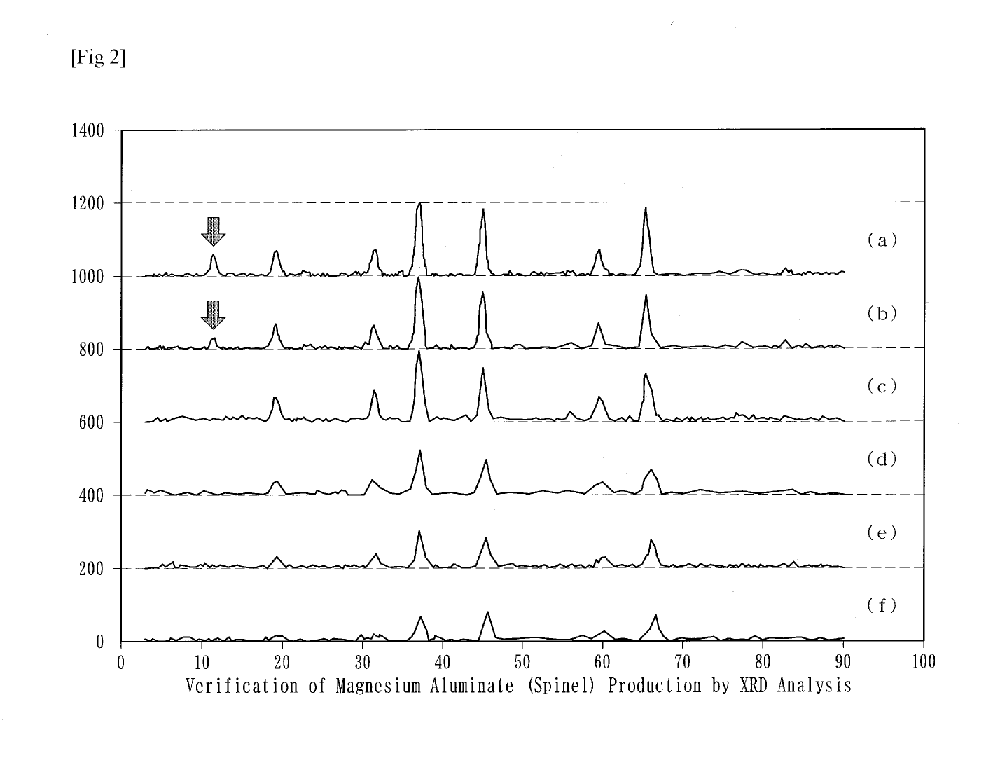

Then, the alumina powder whose pores had been filled with the aqueous solution by using the pore-filling method was subjected to drying in an oven at 110° C. for 12 hours. After having undergone a calcination step at 600° C. for 2 hours, the alumina powder was subjected to firing in air at 1000° C. for 5 hours (a firing step) to produce a catalyst support including magnesium aluminate (MgAl₂O₄). XRD analysis demonstrated that the resulting catalyst support included magnesium aluminate (MgAl₂O₄) (see FIG. 2(a)).

FIG. 2(a) illustrates data of a catalyst support (hereinafter, referred to as Example 1) including 100 mol % magnesium aluminate (MgAl₂O₄). FIG. 2(b) illustrates data of a catalyst support (hereinafter, referred to as Example 2) including 70 mol % magnesium aluminate (MgAl₂O₄). FIG. 2(c) illustrates data of a catalyst support (hereinafter, referred to as Example 3) including 50 mol % magnesium aluminate (MgAl₂O₄). FIG. 2(d) illustrates data of a catalyst support (hereinafter, referred to as Example 4) including 30 mol % magnesium aluminate (MgAl₂O₄). FIG. 2(e) illustrates data of a catalyst support (hereinafter, referred to as Example 5) including 20 mol % magnesium aluminate (MgAl₂O₄). FIG. 2(f) illustrates data of a catalyst support (hereinafter, referred to as Example 6) including 10 mol % magnesium aluminate (MgAl₂O₄). These data were verified using XRD analysis.

In view of the above, magnesium aluminate (MgAl₂O₄) having 10 to 70 mol % (or any other suitable ratio) can be prepared by optionally adjusting a concentration of an aqueous solution as obtained in the solution-preparation step. In addition, in the case of 100 mol % magnesium aluminate (MgAl₂O₄) according to Example 1 and in the case of 70 mol % magnesium aluminate (MgAl₂O₄) according to Example 2, a small peak which was identified as Mg₆Al₂(OH)₁₈.4.5H₂O was observed as indicated by an arrow in FIGS. 2(a) and (b).

With regard to the above Examples 1 to 6, a specific surface area and a pore volume were determined using a nitrogen adsorption method, and were listed in the following Table 1. As demonstrated in this Table 1, any of the Examples provided powder which had been prepared by firing at 1000° C., and had a high specific surface area of about 100 m²/g and a pore volume of about 0.5 ml/g. Accordingly, any of the Examples are suitable for use as a catalyst support.

TABLE 1
Specific Surface Area and Pore Volume of Spinel Produced
by Firing at 1000° C. for 5 Hours

| Spinel | Specific Surface | Pore |
|---|---|---|
| Catalyst Support | Area [m²/g] | Volume [ml/g] |
| Example 1 | 83 | 0.45 |
| Example 2 | 92 | 0.46 |
| Example 3 | 110 | 0.49 |
| Example 4 | 114 | 0.54 |
| Example 5 | 138 | 0.59 |
| Example 6 | 119 | 0.61 |

### Experiment 2

### Preparation and Purification Activity of 50 mol % Magnesium Aluminate/3% Palladium-Supported (3% Pd/50% Spinel) Catalyst

First, 1.8 g of a nitric acid aqueous solution having dinitro diammine Pd containing 8.3 wt % of Pd (palladium) was diluted with distilled water at a volume of 2.4 ml to prepare an aqueous solution. This aqueous solution was added dropwise to 5 g of powder of Example 3 as obtained in Experiment 1. Next, the mixture was mixed in a mortar, and pores of the powder were filled with the foregoing aqueous solution.

Then, the mixture was subjected to drying in an oven at 110° C. for 12 hours. After having undergone a calcination step at 600° C. for 2 hours, the mixture was subjected to firing in air at 1000° C. for 5 hours (a firing step) to produce a catalyst including 50 mol % magnesium aluminate (MgAl₂O₄) on which 3 wt % of Pd was supported (50 mol % spinel (3% Pd/50 mol % spinel)) (hereinafter, referred to as Example 7). The size of Pd particles in the resulting catalyst was determined by measuring an amount of chemical adsorption of CO, and found to be approximately 41 nm.

In addition, 3 wt % Pd was supported on the catalyst supports of Examples 1, 2, and 4 as obtained in Experiment 1 in a similar procedure to produce a 3% Pd/100 mol % spinel catalyst (hereinafter, referred to as Example 8), a 3% Pd/70 mol % spinel catalyst (hereinafter, referred to as Example 9), and a 3% Pd/30 mol % spinel catalyst (hereinafter, referred to as Example 10), respectively. Further, an alumina catalyst having 3 wt % Pd supported thereon (3% Pd/Al₂O₃) was prepared by using a pore-filling method. After having undergone a calcination step at 600° C. for 2 hours, the alumina catalyst was subjected to firing in air at 900° C. for 10 hours to produce a catalyst of Comparative Example for comparison with Examples of the present embodiments.

### Experiment 3

### Purification Activity and Thermal Durability at 900° C. of Catalyst of Example 7 (3% Pd/50 mol % Spinel Catalyst)

A catalyst of Example 7 as obtained in Experiment 3 was molded into a pellet, ground, and subjected to screen sizing to produce powder at a size of 0.25 to 1.0 mm. A purification activity was evaluated by using 0.5 ml (corresponding to about 0.26 g) of the powder. The composition of a simulated gas which had been used in this activity evaluation was NO: 1500 ppm, CO: 0.65%, C₃H₈: 180 ppm, C₃H₆: 180 ppm, and O₂: 0.50%. Nitrogen was used as balance gas. Also, the total gas flow rate was set to 1 l/min (corresponding to a space velocity: 120000 hr⁻¹).

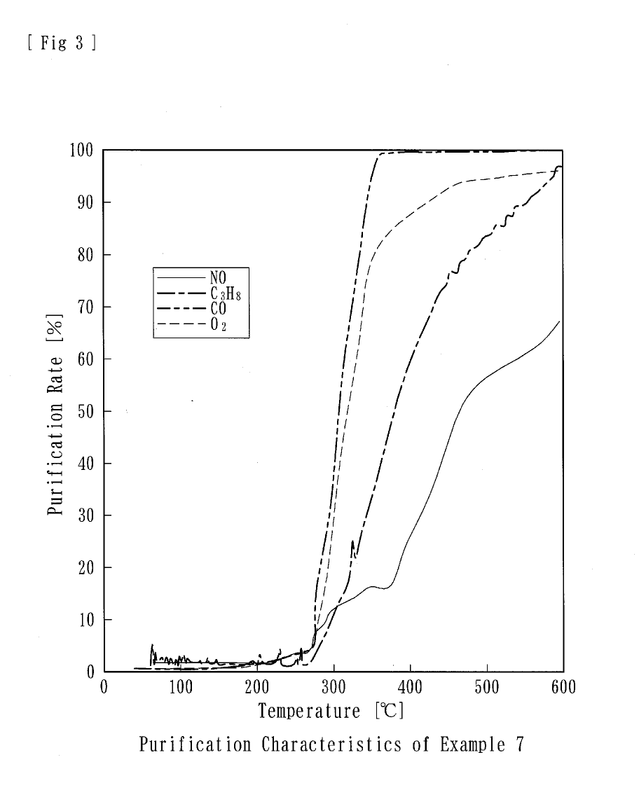

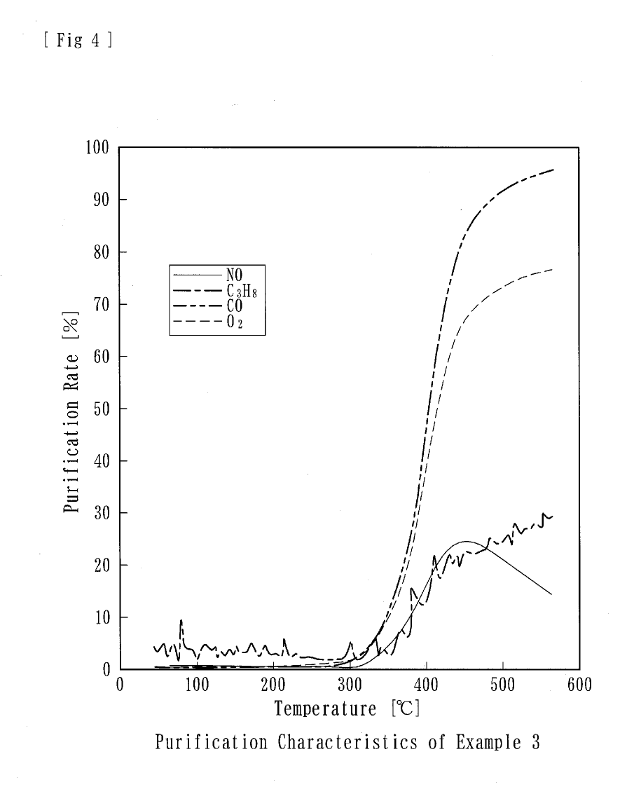

Then, a temperature of a catalyst layer rises from room temperature to 600° C. at a rate of 45° C./min. Gas compositions at an inlet and outlet of the catalyst layer were determined using infrared spectroscopy and magnetic oxygen analysis at the respective temperatures of the temperature rise process. Finally, the purification activity was evaluated. FIG. 3 shows the evaluation results. In addition, under similar conditions, the purification activity of the catalyst support of Example 3 was evaluated. FIG. 4 shows the evaluation results. In view of the above, even the catalyst support (Example 3) including 50 mol % spinel alone can achieve HC and CO oxidation activities and an NO reduction activity. However, compared with a catalyst having Pd supported thereon, a degree of the activity was found markedly low so that an effect of Pd supported thereon was demonstrated.

In addition, in order to examine thermal durability of a catalyst of Example 7 (a 3% Pd/50 mol % spinel catalyst), thermal treatment was carried out at 900° C. for 10 hours, 50 hours, 100 hours, 150 hours, or 200 hours. Then, by using a similar procedure as described above, HC, CO, and NO purification activities were measured at 450° C. and 500° C. The measured results were listed in the following Table 2.

TABLE 2
Durability of Example 7 at 900° C.

| | Purification Rate | | | Purification Rate | | |
|---|---|---|---|---|---|---|
| | at 450° C. | | | at 500° C. | | |
| Treatment Time | HC | CO | NO | HC | CO | NO |
| at 900° C. | [%] | [%] | [%] | [%] | [%] | [%] |
| 10 Hours | 74.1 | 99.7 | 43.0 | 83.9 | 99.7 | 53.4 |
| 50 Hours | 73.7 | 99.2 | 52.2 | 82.4 | 99.5 | 62.4 |
| 100 Hours | 81.7 | 99.5 | 49.9 | 78.8 | 99.8 | 48.9 |
| 150 Hours | 71.8 | 99.6 | 38.6 | 82.4 | 99.6 | 51.5 |
| 200 Hours | 61.5 | 99.7 | 31.7 | 74.6 | 99.7 | 50.2 |

### Experiment 4

### Purification Activity and Thermal Durability at 900° C. of Catalysts of Examples 8 to 10 and Comparative Example

In a manner similar to that of Experiment 3, catalyst activities of catalysts according to Examples 8 to 10 and a catalyst according to Comparative Example were observed, and HC, CO, and NO purification rates at 450° C. and 500° C. were determined. In addition, in a manner similar to that of Experiment 3, thermal treatment was carried out at 900° C. for 10 hours, 50 hours, 100 hours, 150 hours, or 200 hours (with regard to Comparative Example, the thermal treatment was up to 150 hours). Then, by using a similar procedure as described above, HC, CO, and NO purification activities were measured at 450° C. and 500° C. The measured results were listed in the following Tables 3 to 6.

TABLE 3
Durability of Example 8 at 900° C.

| | Purification Rate | | | Purification Rate | | |
|---|---|---|---|---|---|---|
| | at 450° C. | | | at 500° C. | | |
| Treatment Time | HC | CO | NO | HC | CO | NO |
| at 900° C. | [%] | [%] | [%] | [%] | [%] | [%] |
| 10 Hours | 65.9 | 98.0 | 35.0 | 72.2 | 99.4 | 38.0 |
| 50 Hours | 61.9 | 99.8 | 33.8 | 69.6 | 99.8 | 42.7 |
| 100 Hours | 70.6 | 99.7 | 40.0 | 78.8 | 99.7 | 54.9 |
| 150 Hours | 73.6 | 99.7 | 31.5 | 86.4 | 99.5 | 52.1 |
| 200 Hours | 65.4 | 99.8 | 30.0 | 84.6 | 99.7 | 71.2 |

TABLE 4
Durability of Example 9 at 900° C.

| | Purification Rate | | | Purification Rate | | |
|---|---|---|---|---|---|---|
| | at 450° C. | | | at 500° C. | | |
| Treatment Time | HC | CO | NO | HC | CO | NO |
| at 900° C. | [%] | [%] | [%] | [%] | [%] | [%] |
| 10 Hours | 73.8 | 99.7 | 40.2 | 83.5 | 99.7 | 53.7 |
| 50 Hours | 62.7 | 99.8 | 27.3 | 75.8 | 99.7 | 45.1 |
| 100 Hours | 67.9 | 99.7 | 38.4 | 81.1 | 99.7 | 57.9 |
| 150 Hours | 66.3 | 99.7 | 28.8 | 74.9 | 99.7 | 40.7 |
| 200 Hours | 62.0 | 99.8 | 34.4 | 80.0 | 99.7 | 61.7 |

TABLE 5
Durability of Example 10 at 900° C.

| | Purification Rate | | | Purification Rate | | |
|---|---|---|---|---|---|---|
| | at 450° C. | | | at 500° C. | | |
| Treatment Time | HC | CO | NO | HC | CO | NO |
| at 900° C. | [%] | [%] | [%] | [%] | [%] | [%] |
| 10 Hours | 78.0 | 99.7 | 39.3 | 87.6 | 99.6 | 52.1 |
| 50 Hours | 72.2 | 99.7 | 42.7 | 81.6 | 99.7 | 56.9 |
| 100 Hours | 66.9 | 99.8 | 43.9 | 75.4 | 99.8 | 53.1 |
| 150 Hours | 74.6 | 99.7 | 48.1 | 85.4 | 99.7 | 62.8 |
| 200 Hours | 62.0 | 99.8 | 30.5 | 73.3 | 99.8 | 46.6 |

TABLE 6
Durability of Comparative Example at 900° C.

| | Purification Rate | | | Purification Rate | | |
|---|---|---|---|---|---|---|
| | at 450° C. | | | at 500° C. | | |
| Treatment Time | HC | CO | NO | HC | CO | NO |
| at 900° C. | [%] | [%] | [%] | [%] | [%] | [%] |
| 10 Hours | 69.2 | 99.7 | 32.2 | 83.6 | 99.5 | 52.6 |
| 50 Hours | 66.7 | 99.7 | 29.4 | 80.4 | 99.5 | 49.5 |
| 100 Hours | 63.5 | 99.8 | 24.6 | 79.6 | 99.5 | 47.9 |
| 150 Hours | 60.8 | 99.8 | 21.3 | 77.2 | 99.5 | 47.3 |
| 200 Hours | — | — | — | — | — | — |

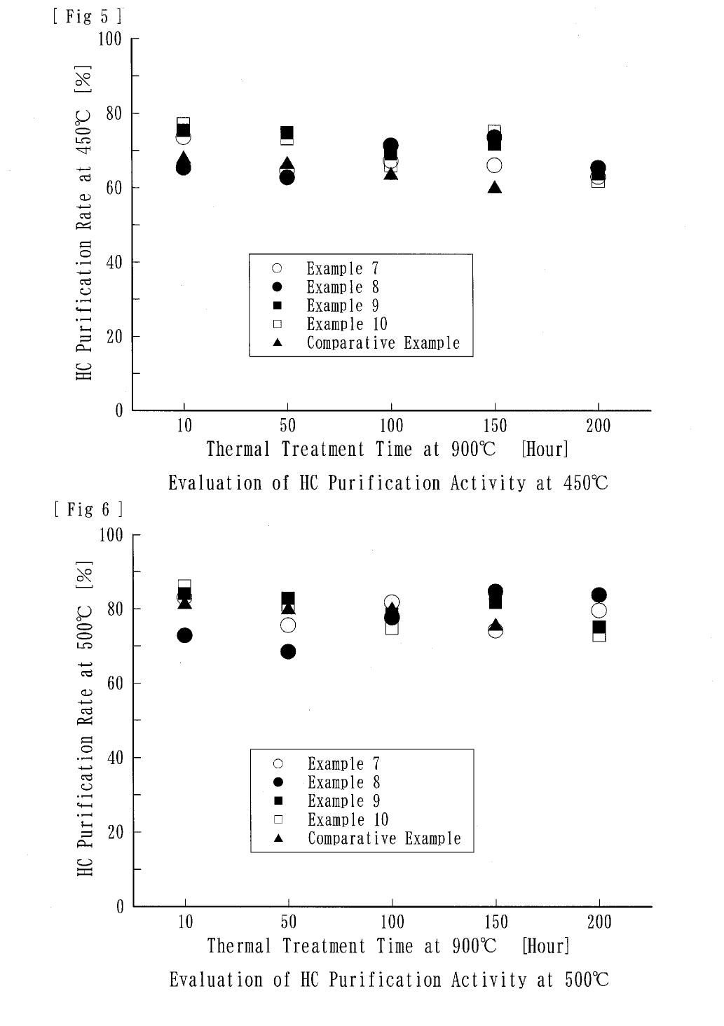

Further, FIGS. 5 to 8 show data demonstrating purification activities of the catalysts of Examples 7 to 10 and Comparative Example, in particular, HC and NO purification activities and durability. As demonstrated in FIGS. 5 and 6, approximately similar HC purification activities were exhibited between Examples 7 to 10 and Comparative Example. As to the catalyst which had been treated for 200 hours, the purification rates of about 65% at 450° C. and about 80% at 500° C. were obtained.

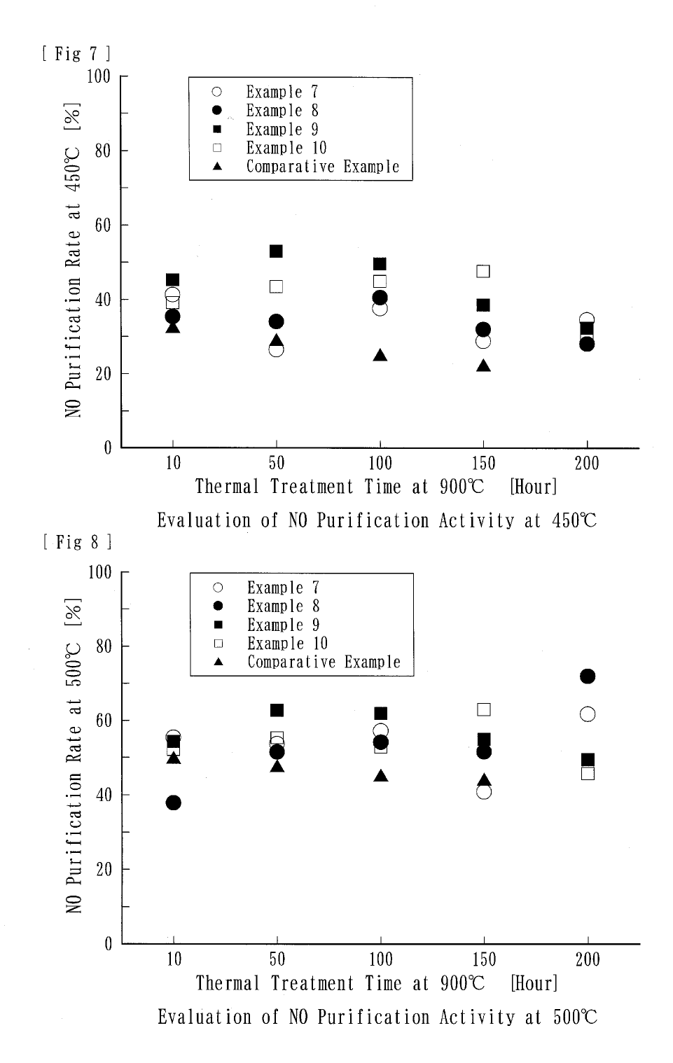

In contrast, with regard to an NO purification activity, as indicated in FIGS. 7 and 8, Examples 7 to 10 had higher activities than Comparative Example. When compared to the catalysts which had been treated for 150 hours, Comparative Example exhibited purification rates of 20% or more at 450° C. and 45% at 500° C., and Examples 7 to 10 exhibited purification rates of 30 to 50% at 450° C. and 45 to 65% at 500° C. This is because in Examples 7 to 10, magnesium ions are uniformly dispersed on the catalyst surface and NOₓ is presumed to be enriched in a vicinity of the magnesium ions.

### Experiment 5

### Activity Changes Due to Oxygen Level Variation

Usually, an oxygen level of exhaust gas varies depending on fuel combustion conditions. The exhaust gas having a high oxygen level is referred to as “lean”, and the exhaust gas having a low oxygen level is referred to as “rich”. Catalyst purification performance is altered depending on the respective conditions. The simulated exhaust gas composition as used in Experiment 3 has a typical composition as flue gas at a theoretical air fuel ratio (i.e., a stoichiometric weight ratio of air to fuel used in combustion is 14.7).

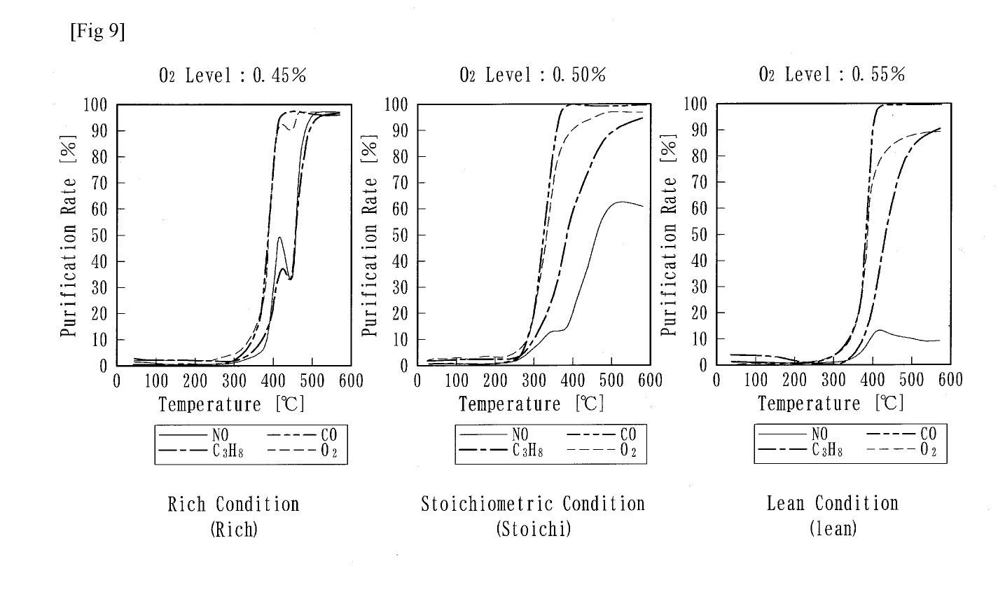

In this Experiment, simulated exhaust gas having a composition with a little higher oxygen level (O₂: 0.55%) and simulated exhaust gas having a composition with a little lower oxygen level (O₂: 0.45%) were used. Then, activities of the catalyst (treated at 900° C. for 100 hours) according to Example 7 under each condition were observed. FIG. 9 shows the observed results. In addition, catalytic activity evaluations were conducted using a procedure similar to that of Experiment 3. The HC, CO, and NO purification rates were determined at 450° C. and 500° C. Table 7 shows the measured results.

TABLE 7
Activity Changes Associated with Oxygen Level Variation

| | Purification Rate | | | Purification Rate | | |
|---|---|---|---|---|---|---|
| | at 450° C. | | | at 500° C. | | |
| | HC | CO | NO | HC | CO | NO |
| Oxygen Level [%] | [%] | [%] | [%] | [%] | [%] | [%] |
| 0.45 (Rich) | 37.5 | 99.7 | 36.3 | 94.7 | 99.2 | 98.5 |
| 0.50 (Stoichi) | 81.7 | 99.5 | 49.9 | 78.8 | 99.8 | 48.9 |
| 0.55 (Lean) | 69.8 | 100.0 | 11.0 | 84.9 | 100.0 | 9.5 |

As indicated in FIG. 9, in the rich condition, CO oxidation reaction preferentially proceeded until 450° C. The CO was completely oxidized, and almost all the oxygen was found to be consumed. In addition, it was demonstrated that an HC-mediated NOₓ reduction reaction proceeded at 450° C. or higher. In contrast, in the lean condition, even after complete oxidation of CO, about 0.1% of oxygen remained. Accordingly, HC oxidation reaction more preferentially proceeded than the HC-mediated NOₓ reduction reaction. Because of this, the NOₓ purification rate failed to increase, and was 15%.

Next, with regard to a ceria-spinel catalyst (20% CeO₂/SPN: Example 11) produced by: having a cerium-dioxide-addition step of adding cerium dioxide (CeO₂) to the magnesium aluminate as produced in the firing step; and having a precious metal (Pd) supported on the catalyst support which had undergone the cerium-dioxide-addition step, heat treatment conditions were optionally modified (at 600° C. for 4 hours, at 900° C. for 5 hours, or at 900° C. for 50 hours). In these cases, experimental results concerning purification rates at 450° C. (HC, CO, and NO purification rates) and purification rates at 500° C. (HC, CO, and NO purification rates) are designated in the following Table 8. It is notable that this Table 8 also sets forth temperatures at which amounts of hydrocarbon (propane) and carbon monoxide become half (T50HC and T50CO).

TABLE 8

| | Purification Rate | | | Purification Rate | | | | |
|---|---|---|---|---|---|---|---|---|
| Thermal | at 450° C. | | | at 500° C. | | | | |
| Treatment | HC | CO | NO | HC | CO | NO | T(50)HC | T(50)CO |
| Condition | [%] | [%] | [%] | [%] | [%] | [%] | [° C.] | [° C.] |
| 600-4 | 97.05 | 100.00 | 95.48 | 98.15 | 100.00 | 94.73 | 306 | 218 |
| 900-5 | 94.12 | 99.85 | 93.63 | 69.32 | 100.00 | 92.64 | 348 | 276 |
| 900-50 | 89.89 | 99.85 | 89.75 | 95.88 | 100.00 | 92.83 | 350 | 277 |

In addition, as Comparative Examples, a catalyst (20% CeO₂/ZrO₂) in which cerium dioxide (CeO₂) was added to ZrO₂ instead of magnesium aluminate and a catalyst (20% CeO₂/Al₂O₃) in which cerium dioxide (CeO₂) was added to Al₂O₃ instead of magnesium aluminate were used. In a manner similar to that of the above Example 11, heat treatment conditions were optionally modified (at 600° C. for 4 hours, at 900° C. for 5 hours, or at 900° C. for 50 hours). In these cases, experimental results concerning purification rates at 450° C. (HC, CO, and NO purification rates) and purification rates at 500° C. (HC, CO, and NO purification rates) are designated in the following Tables 9 and 10, respectively. It is notable that these Tables 9 and 10 also set forth temperatures at which amounts of hydrocarbon (propane) and carbon monoxide become half (T50HC and T50CO).

TABLE 9

| Thermal | Purification Rate | | | Purification Rate | | | | |
|---|---|---|---|---|---|---|---|---|
| Treatment | at 450° C. | | | at 500° C. | | | T(50)HC | T(50)CO |
| Condition | HC [%] | CO [%] | NO [%] | HC [%] | CO [%] | NO [%] | [° C.] | [° C.] |
| 600-4 | 96.34 | 99.69 | 87.33 | 100.00 | 99.85 | 85.56 | 287 | 243 |
| 900-5 | 84.52 | 99.54 | 75.70 | 90.48 | 99.69 | 80.18 | 338 | 261 |
| 900-50 | 71.54 | 99.53 | 45.78 | 81.30 | 99.38 | 61.08 | 402 | 314 |

TABLE 10

| Thermal | Purification Rate | | | Purification Rate | | | | |
|---|---|---|---|---|---|---|---|---|
| Treatment | at 450° C. | | | at 500° C. | | | T(50)HC | T(50)CO |
| Condition | HC [%] | CO [%] | NO [%] | HC [%] | CO [%] | NO [%] | [° C.] | [° C.] |
| 600-4 | 99.17 | 99.53 | 87.47 | 100.00 | 99.84 | 85.04 | 290 | 229 |
| 900-5 | 90.40 | 99.55 | 85.00 | 96.00 | 99.70 | 89.27 | 357 | 289 |
| 900-50 | 84.65 | 99.39 | 66.87 | 93.31 | 99.69 | 77.37 | 368 | 299 |

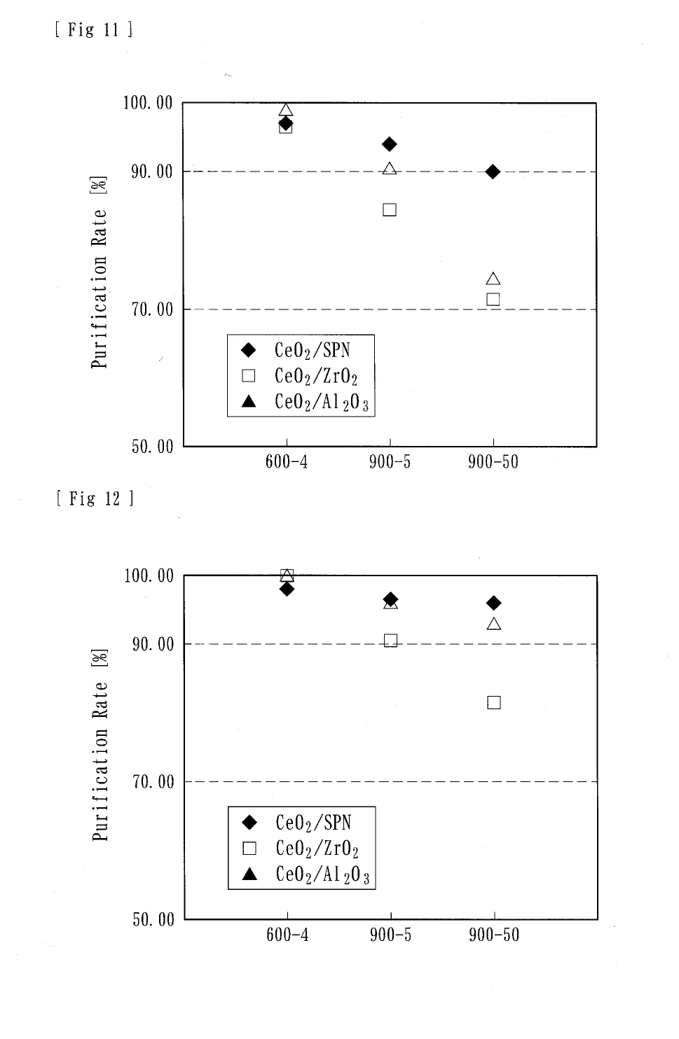

Among the above experimental results, a comparison regarding HC purification rates (at 450° C.) between Example 11 and Comparative Examples is shown in a graph of FIG. 11. A comparison regarding HC purification rates (at 500° C.) between Example 11 and Comparative Examples is shown in a graph of FIG. 12. As it is clear from these graphs, the catalyst of Example 11 can maintain a higher purification rate than those of Comparative Examples when the heat treatment conditions have been variously modified.

### INDUSTRIAL APPLICABILITY

A catalyst support or catalyst and a process for producing the same may apply to other embodiments, the catalyst support or catalyst including magnesium aluminate (MgAl₂O₄) having a specific surface area of 80 to 150 m²/g and a pore volume of 0.45 to 0.65 ml/g, the magnesium aluminate capable of having a precious metal supported thereon.

### REFERENCE SIGNS LIST

S1 Solution-preparation step
S2 Solution-filling step
S3 Drying step
S4 Calcination step
S5 Firing step
S6 Precious-metal-supporting step

What is claimed is:

1. A process for producing a catalyst support produced by having magnesium aluminate (MgAl₂O₄) formed in pores of porous alumina, the magnesium aluminate having a precious metal supported thereon, the process comprising:
a solution-preparation step of preparing a magnesium-ion-containing aqueous solution;
a solution-filling step of filling the pores of the porous alumina with the aqueous solution obtained in the solution-preparation step by using a pore-filling method utilizing capillarity occurring in the pores;
a drying step of drying the porous alumina having the pores filled with the aqueous solution in the solution-filling step; and
a firing step of firing the porous alumina as obtained in the drying step to produce magnesium aluminate.

2. The process for producing a catalyst support according to claim 1, wherein a concentration of the aqueous solution as obtained in the solution-preparation step is optionally adjusted so that an amount of the magnesium aluminate as formed on the porous alumina during the firing step is adjustable.

3. The process for producing a catalyst support according to claim 1 further comprising a cerium-dioxide-addition step of adding cerium dioxide (CeO₂) to the magnesium aluminate as produced in the firing step.

4. A process for producing a catalyst produced by having magnesium aluminate (MgAl₂O₄) formed in pores of porous alumina, the magnesium aluminate having a precious metal supported thereon, the process comprising:
a solution-preparation step of preparing a magnesium-ion-containing aqueous solution;
a solution-filling step of filling the pores of the porous alumina with the aqueous solution as obtained in the solution-preparation step by using a pore-filling method utilizing capillarity occurring in the pores;
a drying step of drying the porous alumina having the pores filled with the aqueous solution in the solution-filling step; and
a firing step of firing the porous alumina as obtained in the drying step to produce magnesium aluminate,
wherein the pores of the porous alumina fired in the firing step are filled with a precious-metal-containing aqueous solution by using the pore-filling method utilizing capillarity occurring in the pores of the porous alumina.

5. The process for producing a catalyst according to claim 4, wherein the precious metal is palladium.

6. The process for producing a catalyst according to claim 4 further comprising a cerium-dioxide-addition step of adding cerium dioxide (CeO₂) to the magnesium aluminate as produced in the firing step, wherein the precious metal is supported on a catalyst support which has undergone the cerium-dioxide-addition step.

7. A catalyst support, comprising magnesium aluminate (MgAl₂O₄) having a specific surface area of 80 to 150 m²/g and a pore volume of 0.45 to 0.65 ml/g, the magnesium aluminate being configured to support a precious metal.

8. The catalyst support according to claim 7, wherein the catalyst support is produced by having the magnesium aluminate (MgAl₂O₄) formed in pores of porous alumina.

9. The catalyst support according to claim 7, wherein cerium dioxide (CeO₂) is added to the magnesium aluminate.

10. A catalyst, comprising a catalyst support including magnesium aluminate (MgAl₂O₄) having a specific surface area of 80 to 150 m²/g and a pore volume of 0.45 to 0.65 ml/g, wherein a precious metal is supported on the magnesium aluminate.

11. The catalyst according to claim 10, wherein the catalyst support is produced by having the magnesium aluminate (MgAl₂O₄) formed in pores of porous alumina.

12. The catalyst according to claim 10, wherein the precious metal is palladium.

13. The catalyst according to claim 10, wherein cerium dioxide (CeO₂) is added to the magnesium aluminate; and the precious metal is supported on the catalyst support containing the cerium dioxide.
